(19) United States
(12) Patent Application Publication
(10) Pub. No.: US 2007/0083025 A1
(43) Pub. Date: Apr. 12, 2007

(54) Compound and method of improving wrinkle resistance in fabrics, and device for containing such a compound

(75) Inventors: Amar Amar Mavinkurve, Nijmegen (NL); Lanying Ji, Singapore (SG); Leo Hubert Maria Krings, Singapore (SG)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Phillips Electronics N.V.

(21) Appl. No.: 10/579,382

(22) PCT Filed: Nov. 10, 2004
(86) PCT No.: PCT/IB04/52363

§ 371 Date: May 11, 2006

(30) Foreign Application Priority Data
Nov. 13, 2003 (EP) 03104187.4

(51) Int. Cl. C08G 77/04

(52) U.S. Cl. 528/26

(57) ABSTRACT

The invention relates to a compound for improving the wrinkle resistance in fabrics, comprising: a wrinkle-reducing active substance, comprising at least one softening agent, and a liquid carrier for carrying the active substance. The invention also relates to a wrinkle-reducing active substance as used in such a compound. The invention further relates to a device for containing such a compound. Moreover, the invention relates to a method of improving the wrinkle resistance in a fabric by the use of such a compound.

The invention relates to a compound for improving the wrinkle resistance in fabrics, comprising: a wrinkle-reducing active substance, comprising at least one softening agent, and a liquid carrier for carrying the active substance. The invention also relates to a wrinkle-reducing active substance as used in such a compound. The invention further relates to a device for containing such a compound. Moreover, the invention relates to a method of improving wrinkle resistance in a fabric through the use of such a compound.

In terms of a long-lasting ironing result, wrinkle resistance is the property of an ironed garment to resist the formation of wrinkles in the long term, i.e. during wearing or during storage. Wrinkle resistance in a fabric is a result of either a better recovery from a wrinkling deformation, or a higher resistance to wrinkle formation, i.e. the need for a higher force to induce the wrinkles. In general, wrinkles are formed due to two effects: (i) viscoelastic relaxation in the individual fibers, and (ii) inter-fiber and/or inter-yarn friction. With respect to the first issue (i) it is known that when a fabric is creased, e.g. bent to form a wrinkle either during wearing, during the laundry cycle, or during storage, individual fibers lose potential energy due to stress relaxation. This stress relaxation is caused by the fact that energy is dissipated in the fibers by the continuous breaking and reformation of secondary (hydrogen) bonds. This process is accelerated by the transport of moisture into and from the fibers (e.g. during wearing or during the laundry cycle). This results in a reduction of the driving force for recovery. With respect to the second issue (ii) it is known that when a creased fabric is released, the residual energy in the fibers induces the fabric to recover part of the deformation. However, frictional forces between the fibers and yarns may restrict this recovery to some extent.

In order to induce wrinkle resistance in a fabric industrially, two main approaches are used, based on the two aforementioned effects leading to wrinkle formation. In order to suppress viscoelastic relaxation in the individual fibers, the individual fibers can be chemically crosslinked, thereby stabilizing the molecular network within. In order to overcome friction during recovery, fabrics are treated with softeners, which reduce the friction by forming a thin layer of lubricating material around the fibers. Another option to reduce the friction is the use of crosslinked elastic film-forming materials, which materials replace frictional contacts between fibers with elastic junctions that provide an additional source of energy during recovery. Quite often, a combination of both concepts (chemical crosslinking and reduction of inter-fiber friction) is used to induce the optimum wrinkle resistance for a given system.

The use of fabric softeners is a well-known technology for reducing the formation of wrinkles or for imparting a degree of wrinkle resistance in fabrics. However, the use of certain softeners can lead to a significantly lower fabric stiffness than in the reference fabric. This results in the treated fabric sometimes being subjected to greater wrinkling deformations during wearing, which leads to more severe wrinkling than in the reference fabric. However, under the same wrinkling deformation (e.g. in certain objective wrinkling tests), the treated fabric shows a better recovery than the reference fabric, i.e. less wrinkling. To obtain a balance between these two situations, it is desirable to have a softener that is capable of reducing friction during recovery, but maintaining the stiffness of the fabric within a certain range with respect to the stiffness of a reference fabric.

It is an object of the invention to provide a compound for improving wrinkle resistance in fabrics with which a relatively good recovery of the fabric can be obtained, while a relatively good stiffness will be maintained.

This object can be achieved by a compound according to the preamble and characterized in that the wrinkle-reducing active substance further comprises at least one crosslinking agent for substantially crosslinking said softening agent at increased temperature. A controlled crosslinking of the softening agent will cause the compound not only to show a satisfying wrinkle recovery of a fabric, but it will also improve the stiffness of this fabric. In fact, the crosslinks present between the yarns and fibers of the fabric result in an increased stiffness. Thus, the controlled crosslinking of the softening agent provides a good balance between the stiffness and the wrinkle recovery of the fabric. During controlled crosslinking the active substance may become an advantageous viscoelastic substance, with which said balance can be obtained. This viscoelastic material has a measurable viscosity as well as a measurable elasticity. Viscosity will normally lie in the range of 10-1000 Pas, and the dynamic storage modulus (G′) will commonly lie in the range of 0.01-0.1 MPa (measured at a frequency of 1 Hz). Preferably, the viscosity is about 200 Pas, and the dynamic storage modulus about 0.05 MPa After application of the compound according to the invention onto a fabric, wrinkling of the fabric will occur less easily, while its wrinkle recovery remains at the conventional advantageous level. A highly crosslinked compound would lead to an elastomeric coating rather than to a softening agent. The crosslinking process of the softening agent commonly also occurs at room temperature (circa 20° C.), but this process is normally relatively slow, dependening on the concentration of the wrinkle reducing active in the liquid carrier. At a temperature higher than room temperature, preferably between 50 and 100C., the speed of this crosslinking process will be increased significantly, so that, e.g. during ironing, a fabric can easily be provided with an at least partly crosslinked softening agent. It is noted that the liquid carrier will commonly substantially consist of water and/or ethanol.

In a preferred embodiment, every molecule of the softening agent has multiple hydroxyl and/or amino groups. These groups may be formed, for example, by end groups or may be part of side chains of the molecules. With these kinds of reactive groups, crosslinking can be achieved with the use of organically modified polyalkoxy silanes. In this way the crosslinking process can be completed relatively quickly, while the extent of crosslinking of the softening agent can be controlled relatively well.

Preferably, the softening agent is a silicon-based softening agent. A (curable) silicon-based softening agent, like e.g. PolyDiMethylSiloxane (PDMS), is commonly very suitable for use as a softening agent due to its relatively low viscosity and its lubricating properties (resulting in a low shear stress), commonly resulting—in applied condition—in a low resistance to deformation between the fibers or yarns. Both hydroxy-terminated (modified) silicones and amino-terminated (modified) silicones may be applied as the softening agent in the compound according to the invention due to their strong interaction with the fiber surface.

In another preferred embodiment, the crosslinking agent comprises at least one organically modified polyalkoxy silane. A relatively controlled crosslinking of the softening agent can be achieved in that a silane-based crosslinking agent is used in combination with the silicon-based softening agent. Moreover, the crosslinking process takes place substantially within the timescale (and other boundary conditions) of ironing. More preferably, an alkyl trialkoxy silane is used as the crosslinking agent. Examples of silanes suitable for acting as crosslinking agent are: Alkyl Trialkoxy silanes like Methyl Tri-Methoxy Silane (MTMS) and glycidyl-based silanes like glycidoxypropyl trimethoxy silane.

In a preferred embodiment, the compound further comprises at least one catalyst for crosslinking the softening agent. The use of one or more catalysts can speed up the crosslinking reaction between the softening agent and the crosslinking agent so as to complete the crosslinking process within the timescale of e.g. ironing. Examples of suitable catalysts for this purpose are: aluminum-based salts, aluminum alkoxydes, and Methyl Aluminium Phosphate (MAP).

In another preferred embodiment, the content of the active substance in the liquid carrier is between 2 and 20 percents by weight. Between these values a good dispersion of the active substance in the liquid carrier can be obtained and conserved. In the range of 1 to 40, preferably between 2 and 20, more preferably between 5 and 10 percents by weight, the concentration of the active substance in the liquid carrier is such that the crosslinking reaction between the softening agent and the crosslinking agent will not, or not significantly, be initiated at normal atmospheric temperature (room temperature). Preferably, the crosslinking agent content in the active substance is between 0.5 and 10 percents by weight, preferably 5 weight percent. More preferably, the crosslinking agent content in the active substance is set independence on the amount of reactive groups in the softening agent. With such a relative quantity, the desired crosslinking of the softening agent can be achieved. This crosslinking will then be sufficient to increase the stiffness of the fabric to which the compound is applied to a desired level, while substantially maintaining the relatively high wrinkle recovery capacity. A further increase in the amount of crosslinking agent in the active substance will commonly lead to an over-crosslinked softening agent (too high crosslinking density), which has elastomeric properties rather than softening properties. Consequently, this would result in a too high fabric stiffness.

The compound according to the invention is preferably provided with additives, such as surfactants, fragrances, anti-bacterial additives, etc., as long as the additive does not interfere with the primary function of the silicone softener. The use of additives in a compound according to the invention can be very suitable when the compound is applied on a fabric by means of a domestic appliance, such as a washing machine or an iron.

The invention also relates to a wrinkle-reducing active substance as used in said compound.

The invention further relates to a device for containing such a compound, comprising at least one container for containing at least a part of said compound, which container is provided with at least one outlet for applying said compound onto a fabric. Examples of such a device are: an iron, a spray bottle (for application of the compound onto the fabric prior to ironing), a washing machine, etc. Preferably, the device is formed by a removable cartridge for an iron. In this cartridge the wrinkle-reducing active substance is commonly contained in concentrated form. During application of this substance onto the fabric, the substance is diluted with water, preferably with water contained in a separate water container of the iron, to a desired active substance concentration. For example, the outlet may be formed by a nozzle. Preferably, the device comprises a first container for the at least one softening agent dispersed in a first liquid carrier, and a second container for the at least one crosslinking agent dispersed in a second liquid carrier. A separation of the most essential ingredients of the compound according to the invention can prevent and postpone the initiation of the crosslinking reaction as described above. During the application of the two emulsions onto the fabric these ingredients will be brought into mutual contact, thus initiating the crosslinking reaction. As was noted above, this reaction will normally be accelerated significantly by an increase in the surrounding temperature, e.g. by means of an iron. Since the crosslinking reaction will be commonly accelerated by an increase in the temperature of the compound, it is not always necessary to separate the two basic ingredients within the device, as long as the temperature of this device, and more particularly of the container of the device carrying this compound, is not (significantly) increased.

Moreover, the invention relates to a method of improving the wrinkle resistance in a fabric by means of such a compound, comprising the steps of: A) applying the compound to the fabric, B) removing the wrinkles in the fabric, C) permitting the liquid carrier to evaporate at least partly, and D) crosslinking the softening agent to some extent by increasing the temperature of the fabric. Step C) and step D) are generally applied at the same time. An amount of active substance typically applied, particularly sprayed, onto the fabric is preferably from about 0.5 to about 10 percents by weight, more preferably from about 2 to about 5 percents by weight of the conditioned weight of the fabric. Once an effective amount of compound has been sprayed onto the fabric, the fabric is stretched or smoothed by hand according to step B). After the effective amount of compound has been applied to the fabric, and the latter has preferably been stretched, the liquid, in particular moisture, is permitted to evaporate at least substantially. If steps C) and D) are applied at the same time, evaporation will occur in an active, forced way owing to an increase in temperature of the fabric. The reaction between the softening agent and the crosslinking agent will be initiated during this temperature increase. The softening agent will be crosslinked to a certain, sufficient extent during this. The evaporation of moisture during the application of an increased temperature will commonly result in stress relaxation in the fibers of the fabric. A decrease in the stored energy will maintain the fabric in its set, i.e. flat, state.

Preferably, the application of the compound onto the fabric according to step A) is realized by means of a domestic appliance. Examples of such domestic appliances are a washing machine, an iron provided with a compound-spraying reservoir, and other spraying devices for a compound according to the invention.

In a preferred embodiment of the invention, the removal of the wrinkles in the fabric according to step B) is realized by means of an iron at an increased temperature compared with an environmental temperature (room temperature). In this way steps C) and D) will commonly be carried out during step B). Thus, the increased temperature will lead both to an accelerated evaporation of applied liquid and to crosslinking of the softening agent. Cooling down of the fabric results commonly in a protective layer formed around the stretched yarns of the fabric. Obviously, the steps A)-D) need not be performed consecutively, but may be performed at the same time.

In yet another preferred embodiment, the softening agent and the crosslinking agent are applied to the fabric separately during step A). As was noted above, it may be advantageous to apply the main ingredients of the compound according to the invention, i.e. the softening agent and the crosslinking agent (disregarding the liquid carrier), separately in order to prevent premature initiation of the crosslinking reaction.

The invention will be further illustrated by means of the following non-limiting example.

### EXAMPLE 1

A commercial fabric softener called Tinotex CMA (supplied by Ciba) was obtained as a 40% emulsion (by weight). Methyl Tri Methoxy Silane (MTMS) was supplied by Aldrich and used as received. MTMS was first hydrolyzed as follows: 25 g of MTMS was mixed with 0.35 g ( 1/60 molar equivalents) of maleic acid and 200 g of ethanol, by stirring well. To this was added, dropwise, 15 g of deionized water. The reaction was allowed to proceed to completion in 15 minutes. The Tinotex CMA was diluted with water until an 8% emulsion (by weight) was obtained. To this was added 3% (by weight of pure compound based on the Tinotex CMA) of the hydrolyzed MTMS (corrected for the concentration of the hydrolyzed MTMS in solution).

This emulsion was sprayed on the cotton samples to be tested (wet pick-up of about 33% of the conditioned weight of the fabric). The samples were ironed to dryness after they had been allowed to dry in air until a wet-pick up of about 20% was attained. A solid pick-up of 2.7% was thus obtained. After ironing, the samples were conditioned for at least 24 hours. The samples were then subjected to the AATCC method 128 (Wrinkle Tester Method). This test method is used to determine the wrinkle recovery of woven fabrics. During this test the samples are wrinkled and compressed under controlled conditions of time (5 minutes) and force (weight of the upper flange, no additional load) to create a wrinkled fabric. The samples are then suspended under conditions of controlled temperature and humidity (21° C., 60% RH) for a controlled recovery period (24 hours), after which the fabric is assessed in comparison with the AATCC replicas. For the sake of comparison, fabrics were treated in a similar way either with water or with just Tinotex CMA (solid pick-up: 2.7%). The results are shown in the following Table.

| Treatment | AATCC score |
|---|---|
| Reference (water) | 2.3 |
| Tinotex CMA | 2.2 |
| Tinotex CMA + 3% MTMS | 2.9 |

This Table shows the results as an AATCC score from I to 5, wherein the lowest AATCC score of 1 represents a very poor appearance and the highest AATCC score of 5 represents with the best appearance.

1. Compound for improving the wrinkle resistance in fabrics, comprising:
a wrinkle-reducing active substance comprising at least one softening agent, and
at least one liquid carrier for carrying the active substance, characterized in that the wrinkle-reducing active substance further comprises at least one crosslinking agent for substantially crosslinking said softening agent at increased temperature.

2. Compound according to claim 1, characterized in that every molecule of the softening agent has multiple hydroxyl and/or amino groups.

3. Compound according to claim 2, characterized in that the softening agent is a silicon-based softening agent.

4. Compound according to claim 1, characterized in that the crosslinking agent comprises at least one organically modified polyalkoxy silane.

5. Compound according to claim 1, characterized in that the compound further comprises at least one catalyst for crosslinking the softening agent.

6. Compound according to claim 1, characterized in that the content of the active substance in the liquid carrier is between 2 and 20 by weight percents.

7. Compound according to claim 1, characterized in that the crosslinking agent content in the active substance is dependent on the amount of reactive groups in the softening agent.

8. Compound according to claim 1, characterized in that the compound is provided with additives, preferably a surfactant, a fragrance, and a preservative.

9. Wrinkle reducing active substance as used in a compound according to claim 1.

10. Device for containing a compound according to claim 1, comprising at least one container for containing at least part of said compound, wherein said container is provided with at least one outlet for applying said compound to a fabric.

11. Device according to claim 10, characterized in that the device comprises a first container for the at least one softening agent dispersed in a first liquid carrier, and a second container for the at least one crosslinking agent dispersed in a second liquid carrier.

12. Device according to claim 10, characterized in that the device is adapted to be removably coupled to an iron.

13. Method of improving the wrinkle resistance in a fabric by the use of a compound according to claim 1, comprising the steps of:
A) applying the compound to the fabric,
B) removing the wrinkles in the fabric,
C) permitting the liquid carrier to evaporate at least partly, and
D) crosslinking the softening agent by increasing the temperature of the fabric.

14. Method according to claim 13, characterized in that the application of the compound to the fabric according to step A) is realized by means of a domestic appliance.

15. Method according to claim 13, characterized in that the removal of the wrinkles in the fabric according to step B) is realized by means of an iron at an increased temperature compared with room temperature.

16. Method according to claim 13, characterized in that step C) is carried out during step B).

17. Method according to claim 13, characterized in that in step A) the softening agent and the crosslinking agent are separately applied to the fabric.
